(19) United States
(12) Patent Application Publication
(10) Pub. No.: US 2022/0148333 A1
(43) Pub. Date: May 12, 2022

(54) METHOD AND SYSTEM FOR ESTIMATING EYE-RELATED GEOMETRIC PARAMETERS OF A USER

(71) Applicant: Eyeware Tech SA, Martigny (CH)

(72) Inventors: Kenneth Alberto FUNES MORA, Lausanne (CH); Jean-Marc ODOBEZ, Clarens (CH); Gang LIU, Beijing (CN); Yu YU, Martigny (CH)

(21) Appl. No.: 17/602,047

(22) PCT Filed: Apr. 6, 2020
(86) PCT No.: PCT/IB2020/053252

§ 371 Date: Oct. 7, 2021

(30) Foreign Application Priority Data
Apr. 10, 2019 (CH) 00487/19

(51) Int. Cl. G06V 40/18; G06T 7/11; G06V 10/75; G06T 7/32; G06T 7/60; G06V 10/82; G06T 1/60; G06V 10/22; G06T 11/00

(52) U.S. Cl. CPC G06V 40/197; G06T 7/11; G06V 10/759; G06T 7/32; G06T 7/60; G06V 10/82; G06T 2207/30201; G06V 10/22; G06T 11/00; G06T 2207/20076; G06T 2207/20021; G06T 2207/20084; G06T 2207/20081; G06T 1/60

(57) ABSTRACT

Method for estimating eye-related geometric parameters of a user, comprising the steps of: a. retrieving one input image observation corresponding to an image of the eye; b. using a learning machine for computing a plurality of image segmentation maps, so as to classify each pixel into one eye region; c. generating through a set of geometric parameters an image geometric model of the user's eye; d. comparing the image geometric model with an image segmentation map; e. computing a model correspondence value indicating if said input image observation corresponds to the geometric model; f. repeating steps c. to e. if the value computed under step e. is below an optimal value wherein one parameter is changed for each iteration until said model correspondence value reaches the optimal value, and g. retrieving the eye-related geometric parameters from the latest model of the user's eye.

### FIELD OF THE INVENTION

The present invention relates to a method and a system for estimating eye-related geometric parameters of a user, in particular the gaze estimation, i.e. the estimation of the direction of the gaze of a user, notably for human-machine interfacing, Virtual Reality, health caring and for mobile applications.

### DESCRIPTION OF RELATED ART

Eye-related geometric parameters, such as the gaze direction of a user, provide important cues of human behaviours. Gaze directions and movements thereof are indicators of the visual attention as well as of given thoughts and mental states of people.

Gaze estimation provides thus a support to domains like Human-Robot-Interaction (HRI), Virtual Reality (VR), social interaction analysis, or health care. With the development of sensing function on mobile phones, gaze estimation can furthermore provide a support to a wider set of applications in mobile scenarios.

Gaze estimation can be divided into two main classes, i.e. geometric methods and appearance-based methods. Geometric methods rely on geometric models of the eye whose parameters are usually estimated from geometric features, through common methodology called Pupil Centre and Corneal Reflection or PCCR methods, extracted from the eye images. These models can be very precise, but due to their dependency on robust features extraction, high resolution images of the eyes are often required, limiting the mobility of users and the applicability of such method.

Guestrin and Eizenman's work (EEE Transactions on biomedical engineering 53(6), 1124-1133, June 2006) describes in detail the theory of estimating eye geometric parameters based on pupil centre and corneal reflection strategies. The authors cover different configurations of light sources and multiple cameras which can lead to invariance to head movements or better properties in terms of need for calibration strategies.

Appearance-based methods on the other hand directly map eye images to the gaze direction, and in recent years, data collections of large datasets and deep learning have helped making great progress.

Nevertheless, while these methods can better handle low-resolution images, due to the absence of an explicit eye model, they might also encounter difficulties to adapt models to specific users thereby failing to obtain very accurate results.

The work in K. A. Funes Mora and J.-M Odobez, “Geometric generative gaze estimation (g3e) for remote rgb-d camera.” (CVPR, pp 1773-1780, 2014) tried to reconcile these two sets of approaches. It relied on a geometric generative model which from a given geometric configuration of eyeball parameters was capable of generating coloured eye images. The inference process of such model is capable of retrieving the geometric parameters based on observations of eye image samples which may be augmented with the known point of regard. The inference process would rely on likelihood maps which comprise for each pixel the likelihood of belonging to either the iris, sclera or eyelid skin regions. The likelihood maps were obtained from Gaussian Mixture models applied to the pixel colour and initialized by hand. A likelihood map can also be understood as a colour-driven segmentation of the eye image. Such colour models however are difficult to apply to videos of eye images due to the low image resolution and the concave nature of the eye regions which generate complex shadow patterns. This work is also one embodiment of the invention disclosed in WO 2015/192879.

The work in Proenca Hugo et al. “Segmenting the periocular region using a hierarchical graphical model fed by texture/shape information and geometrical constraints” (International Conference on Biometrics, IEEE, 2014, pages 1-7, XP032714791) discloses an image labelling algorithm for the periocular region that discriminates between seven components (iris, sclera, eyelashes, eyebrows, hair, skin and glasses) according to a model composed of two phases, namely:

1) using several neural networks to infer from a training set posterior probabilities for each image position and class of interest. Each neural network is configured to detect one component and receives local statistics (texture and shape descriptors) from the input data.

2) the posteriors based on data local appearance are combined with geometric constraints and components' adjacency priors, to feed a hierarchical Markov Random Filed (MRF), composed of a pixel and a component layer.

There is room for improvement for retrieving more precisely eye-related geometric parameters of a user which is particularly adapted for both high and low image resolution.

An aim of the present invention is therefore to provide a method and a system for estimating eye-related geometric parameters of a user, for example the eye-gaze direction with better accuracy.

Another aim of the present invention is to provide a method and a system for robust estimation of eye-related geometric parameters of a user, for example the eye-gaze direction even for poor image quality of the user's eye.

A further aim of the present invention is to provide a method and a system with improved performance in image classification and segmentation.

### BRIEF SUMMARY OF THE INVENTION

According to the invention, these aims are achieved by means of a method for estimating eye-related geometric parameters of a user, comprising the steps of:

a. retrieving at least one input image observation corresponding to an image of the user's eye comprising distinctive eye regions;

b. using a learning machine for computing one or a plurality of image segmentation maps, so as to classify each pixel of said input image observation into at least one among a plurality of distinctive eye regions;

c. generating through a set of geometric parameters an image geometric model of the user's eye;

d. comparing the image geometric model with at least one image segmentation map;

e. based on this comparison, computing a model correspondence value indicating if said at least one input image observation corresponds to the geometric model of the user's eye;

f. repeating steps c. to e. if the value computed under step e. is below an optimal value wherein at least one parameter in the set of geometric parameters is changed under step c. to generate a new image geometric model of a user's eye for each iteration of steps c. to e. until said model correspondence value reaches the optimal value, and

g. retrieving the eye-related geometric parameters from the latest image geometric model of the user's eye that has been generated.

In an embodiment, the at least one input image observation is augmented by providing data obtained from supervised, semi-supervised or unsupervised calibration procedures.

In an advantageous embodiment, said eye-related geometric parameters correspond to an eye gaze direction of the user, and wherein:
the image geometric model of the user's eye under step c. corresponds to user's eye gazing at one particular direction,
said at least one parameter in the set of geometric parameters is changed under step c. to generate a new image geometric model of a user's eye gazing at another direction for each iteration of steps c. to e. until said model correspondence value reaches said optimal value, and
the gaze direction is retrieved under step g. from said latest image geometric model.

In an embodiment, at least one parametric segmentation map is calculated from said image geometric model of the user's eye. Each pixel of the parametric segmentation map is classified into at least one among a plurality of distinctive eye regions.

Each pixel of the parametric segmentation map may indicate for example at least one probability, log probability or score that this pixel belongs to at least one distinctive eye region.

A plurality of parametric segmentation map may be calculated from the image geometric model. Each the parametric segmentation maps may indicate, for example, to which distinctive eye region each pixel of a projection of the image geometric model belongs, or a probability, a log probability or a score associated with each pixel of a projection of the image geometric model that this pixel belongs to one distinctive eye region.

In an embodiment, step d. comprises comparing the probability, log probability or score assigned to each pixel of at least one image segmentation map with the value of a pixel of at least one parametric segmentation map having the same coordinates.

In an embodiment, the method for estimating eye-related geometric parameters of a user, may comprise:
determining from at least one parametric segmentation map the distinctive region to which each pixel is supposed to belong according to the image geometric model;
as part of step d., determining from the at least one image segmentation map a pixel correspondence value corresponding to that distinctive region and indicating the probability, log probability or score that this pixel belongs to that distinctive region;
as part of step e., adding said pixel correspondence values together to provide said model correspondence value.

In an embodiment, at least one soft parametric segmentation map of the image geometric model is calculated from the image geometric model of the user's eye. At least two, preferably at least three values are assigned to each pixel of the soft parametric segmentation map. These values represent a probability, a log probability or a score that each pixel corresponds to each of the distinctive eye regions of the image geometric model.

At least two, preferably at least three values may be assigned to each pixel of the image segmentation map. The at least three values represent a probability, a log probability or a score that each pixel corresponds to each of the distinctive eye regions of the at least one input image observation.

In an embodiment, the soft parametric and image segmentation maps are merged together by multiplying each of the at least three values assigned to each pixel of the parametric segmentation map with each of the corresponding at least three values assigned to each pixel of the image segmentation map with the same coordinates. The multiplied values are added for each pixel of the segmentation maps to provide the model correspondence value.

A weighted sum of the probabilities, log probabilities or scores may be computed for each pixel in each image segmentation map with the probability associated with the corresponding value of the corresponding pixel of the image segmentation map.

In an embodiment, the distinctive eye regions are preferably three distinctive eye regions selected from the group comprising the cornea, the pupil, the iris, the sclera and the eyelid.

In an embodiment, the image segmentation maps are image probability maps indicating a probability, a log probability associated with each pixel that this pixel belongs to one distinctive eye region.

In an embodiment, the image segmentation maps are image score maps indicating the score associated with each pixel that this pixel belongs to one distinctive eye region.

In an embodiment, the learning machine comprises a segmentation neural network configured to generate the image segmentation map based on the at least one input image observation.

The segmentation neural network may for example comprise multiple layers configured to generate an image segmentation map for an input.

The segmentation neural network may for example comprise one or a sequence of encoding-decoding or hourglass layers configured to achieve a transformation of the input such that the image segmentation is of the same resolution as the input, or at least a pixel correspondence can be established between the image segmentation map and the input.

In an embodiment, the set of geometric parameters comprises a plurality of parameters among at least: eyeball rotation centre, visual axis offset, eyeball radius, cornea radius, limbus radius, pupil radius, eyelids opening or shape, and left and/or right eye corner.

In an embodiment, the step of retrieving at least one input image observation corresponding to an image of the user's eye having distinctive eye regions comprises pre-processing an image from an image frame. The pre-processing of the image may comprise one or more image adjustments or corrections among: brightness adjustment, contrast adjustment, white balance adjustment, pose head adjustment, noise removal, scaling and/or cropping.

Another aspect of the invention relates to an apparatus for estimating eye-related geometric parameters, comprising:
a camera for capturing a user's face;
   a database storing user-specific eye and facial geometric parameters, and
   a computing system comprising a memory storing a computer program configured to perform the method as described above.

A further aspect of the invention relates to a computer readable storage medium storing a computer program. The computer program comprises a set of algorithms configured to perform the method as described above.

### BRIEF DESCRIPTION OF THE DRAWINGS

The invention will be better understood with the aid of the description of several embodiments given by way of examples and illustrated by the figures, in which:

FIG. 1 illustrates a flowchart of a method for tracking an eye-gaze direction of a user according to an embodiment of the invention,

FIG. 2 illustrates a detailed flowchart of a method according to an embodiment of the invention,

FIG. 3 schematically illustrates a parametric segmentation process of a geometric model of a user's eye,

FIG. 4 schematically illustrates a segmentation process of an image of a user's eye using a segmentation neural network,

FIG. 5 schematically illustrates an evaluation process of an eye-gaze direction of a user,

FIG. 6 schematically illustrates the geometry of an eye, and

FIG. 7 schematically illustrates an apparatus for estimating an eye-gaze direction of the user according to an embodiment of the invention.

### DETAILED DESCRIPTION OF POSSIBLE EMBODIMENTS OF THE INVENTION

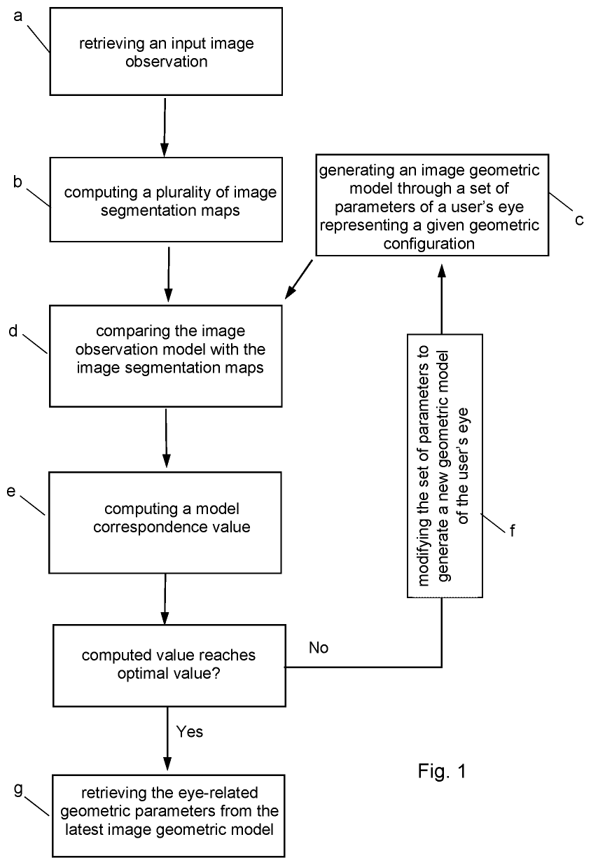

FIG. 1 illustrates a flowchart of the general concept of a method for estimating eye-related geometric parameters θ of a user. The eye-related geometric parameters of the user is estimated through the main steps a. to g. of the illustrated method. While the method according to the invention is particularly adapted to estimate an eye-gaze direction of a user, it may however be used for estimating other eye-related geometric parameters such as the opening degree of the eyelid.

An eye image or a series of eye images of a user's eye is first captured, under step a. The eye image may be for example a colour image, an infrared image, an amplitude image, a grayscale image of a pre-processed version of the image data, and/or any combination of those images. The eye image may be pre-processed using pre-processing steps such as to crop the image, scale it, adapt colour, contrast, white-balance, and/or brightness, remove noise, improve sharpness, etc. In one embodiment, the pre-processing includes a head pose correction in order to correct the rotation angle and position of the head, and the camera viewpoint or the scale of the eye. The pre-processing may also be supported by depth measurements from stereo cameras, structured-light cameras, time-of-flight cameras, or other depth sensing devices. In one embodiment, the head-pose correction is estimated based on 3d models of the facial region and/or depth measurements around the face region. The captured and possibly pre-processed image is hereafter referred to as an input image observation 10.

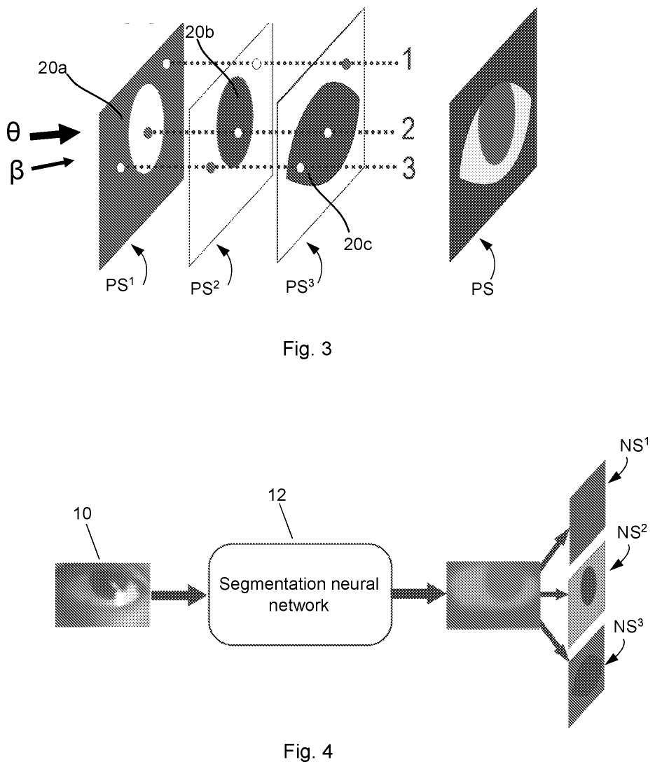

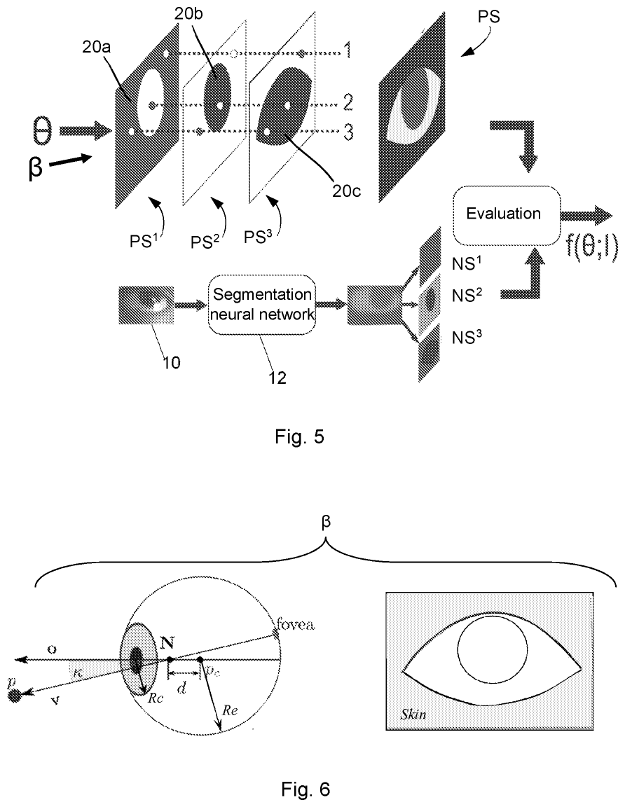

The captured eye image or series of eye images of a user's eye may be augmented by providing ground truth data, such as the point of regard, by retrieving the underlying user specific geometry such as the eyeball radius, position of the head, etc (see FIGS. 3 and 5 in combination with FIG. 6). This information may be available only for a subset of the input eye images and be obtained from explicit or implicit calibration procedures. For example, a user is instructed to gaze at certain points in space. Alternatively, a given behaviour is observed or elicited allowing to retrieve an approximate point of regard, or contextual information such as observed content can be used. The point of regard may then be represented as a probability distribution instead of a single point.

In an embodiment, the input image observation may capture beyond the eye region and can contain the entire body, the entire face, or a region containing both eyes at the same time.

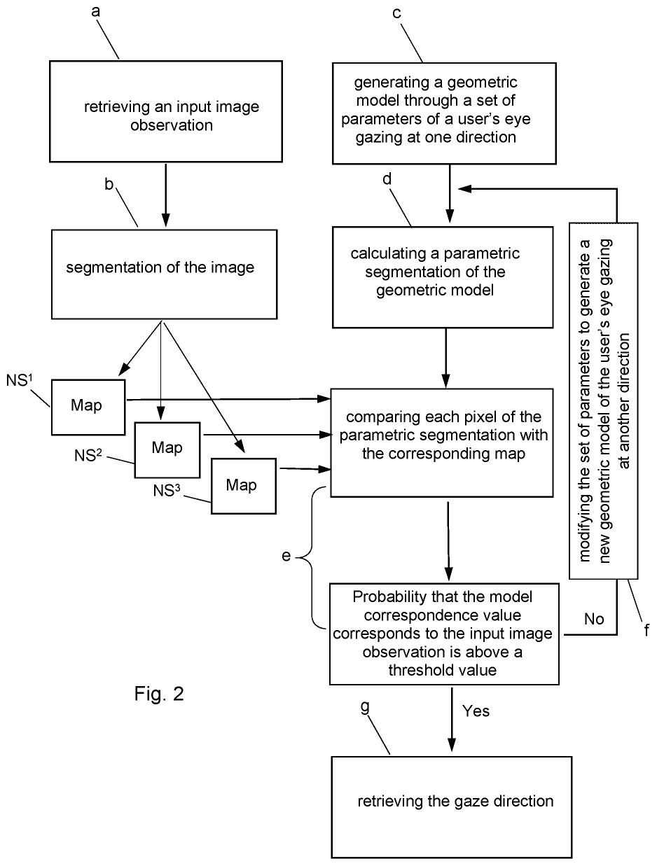

Each pixel of the input image observation 10 is then classified into one among a finite number of distinctive eye regions, for example two or three distinctive eye regions, such as eyelid, cornea, or sclera. The cornea region can be understood as the region comprising the pupil, iris and limbus together. More distinctive eye regions may be needed depending on the application. For example, each pixel of the input image observation 10 may be classified into one among fourth distinctive regions, i.e. the above three distinctive eye regions and an additional distinctive region for the pupil alone for pupillometry applications. The classification is preferably performed with a learning machine, such as a neural network 12, and results into a plurality of image segmentation maps NS¹, NS², NS³ as part of step b. shown in FIGS. 2 and 4. Each image segmentation map is associated with one distinctive eye region and may consist for example in a probability map indicating a probability, a log probability, or a score, that each pixel of the input image observation 10 belongs to the corresponding distinctive eye region.

Under step c, an image geometric model is independently generated, based on a specific geometric configuration as shown in FIG. 1, for example a set of parameters of a user's eye gazing at one particular direction as shown in FIG. 2. With reference to FIG. 6, these parameters may for example include or be any combination of parameters of the eye, such as the eyeball radius Re, the cornea radius Rc, the left and/or right eye corners, etc, and other parameters related to the gazing direction or on other parameters, such as for example the eyeball rotation p_{c}, the visual axis offset k, the nodal point distance from Pc (d). Moreover, during the optimization process, a set of the parameters may be fixed whereas the other parameters are modified to find their optimal values. Statistics or information, such as the standard deviation of the eyeball size for a given population, may also be used as part of the model correspondence value computation, as prior or regularization terms in a similar fashion to WO 2015/192879.

The image geometric model may be a 3D or mathematical model of the eye with a specific geometric configuration on size, position, visual axis, and other geometric values as well as gazing into one particular direction, as well as a 2D or 3D representation of the eyelids shape and opening, which is then represented as a 2D image by projecting that model onto a projection plane, for example a plane perpendicular to the camera pointing direction or a plane pointing from a predefined position with respect to the head coordinate system.

In an embodiment, the image geometric model may be computed from a set of images of the user's eye gazing at a known direction, for example during a calibration session, in order to determine the parameters of the user's eye which are independent from the gazing direction. The calibration may be supervised, unsupervised, or partially supervised. A subset of parameters of the geometric model of the user's eye may also be retrieved without any image of the user eye. For example, a user independent model could initially be used, for instance a model generated from a plurality of eye images from different users. In an embodiment, the geometric model is generated by interpolating models from different users sharing some common features with the user such as sex, ethnicity, age etc. In an embodiment, the fixed parameters of the geometric model may be user independent and defined by a set of geometric statistics, which can be retrieved from prior studies or from the training data for a set of users.

The image geometric model of the user under a first assumed geometric configuration is then compared with the segmentation maps NS¹, NS², NS³ provided by the learning machine (step d). In the case where the geometric configuration to be found is the gazing direction, the first gazing direction may be for example the previously determined eye gazing direction if the method is used for eye tracking the direction of the eye in a series of frames. The gazing direction determines a first set of variable parameters (eyeball rotation pc, the visual axis offset k, the nodal point distance from Pc (d)) of the geometric model.

The first geometric configuration parameters may also be obtained from prior knowledge information such as statistics of eyeball geometry computed over certain demographic groups.

This comparison results in a model correspondence value indicating if the input image observation 10 corresponds to the geometric model of the user's eye gazing at the selected particular direction.

Steps c to e are repeated wherein the set of geometric parameters is changed under step c. to generate a new image geometric model of a user's eye for each iteration of steps c. to e. with the objective of increasing the model correspondence value until said value reaches an optimal value. As for most optimization algorithms, small changes are applied to one or more geometric parameters iteratively in order to get closer to the optimal value. For example, the value of said one or more parameters may be increased or decreased in an attempt to reach the optimal value

In order to reach the optimal value, the variable parameters in the set of geometric parameters may be changed taking into consideration posterior distribution of the set of geometric parameters according to the image observation model. Since the posterior distribution is difficult to derive analytically, a Variational Bayes formulation can be used as an approximate inference technique to find the adequate optical geometric configuration.

Alternative optimization strategies can be used such as grid search strategies, sampling approaches like Markov Chain Monte Carlo (MCMC), newton methods, gradient descent, stochastic gradient descent or other strategies which may help finding rapidly the optimal geometric configuration.

When the model correspondence value indicative of how likely the image observation model corresponds to the image geometric model reaches the optimal value, the gaze direction of the user's eye or any other eye geometric parameter of interest is retrieved under step g. from the latest image geometric model that has been generated.

There are various methodologies to determine how likely the input image observation 10 corresponds to the image geometric model as discussed in detail hereafter.

In an advantageous embodiment and with reference to FIGS. 2, 4 and 5, the input image observation 10 is passed through a segmentation neural network 12 to discriminate the distinctive eye regions of the input image observation 10. In the context of the invention, the segmentation of the input image observation 10 allows to discriminate several semantic regions among a group of regions comprising the cornea/iris region, the sclera region, the pupil region and the eyelid region. The use of semantic regions allows decoupling the gazing process and the user eye geometry from the ambient or sensing conditions.

The segmentation results in a plurality of image segmentation maps NS¹, NS², NS³, each image segmentation map indicating the probability that pixels of one input image observation belongs to one semantic region, i.e., to distinctive eye region such as for example iris, sclera, pupil or eyelid.

In an embodiment, the segmentation map may not have a probabilistic interpretation, but still deliver values representative as how likely it is for a pixel to belong to either of the distinct region. Such non-probabilistic measurements can here be referred as a score.

In a preferred embodiment, each image segmentation map NS¹, NS², NS³ is a probability map indicating a probability at each pixel that this pixel belongs to the corresponding distinctive eye region. For example, as shown in FIG. 4, a first image segmentation map NS¹ may be established for the eyelid and indicates the probability, log probability or score that each pixel of the input image observation 10 belongs to the eyelid; a second segmentation map NS² may be established for the pupil/cornea and indicates the probability that each pixel of the input image observation 10 belongs to the pupil/cornea; a third segmentation map NS³ may be established for the sclera and indicates the probability that each pixel of the input image observation 10 belongs to the sclera, etc.

Independently from the segmentation process of the input image observation 10 through the segmentation neural network 12, a parametric segmentation PS of the image geometric model is calculated from the set of parameters θ to discriminate distinctive eye regions of the image geometric model, resulting into one or a plurality of parametric segmentation maps.

More particularly, the parametric segmentation PS results into a set of parametric segmentation maps containing each a single distinctive eye region of the geometric model which is different to the single distinctive eye region belonging to the other two parametric segmentation maps. For example, as shown in FIG. 3, a first, second and third parametric segmentation maps PS¹, PS², PS³ contain each the portion of the geometric model corresponding respectively to the eyelid region 20a, the iris/cornea region 20b, and the sclera region 20c in order to determine which pixels belong to each of these eye regions

For example, if pixel 1 on the first parametric segmentation map PS¹ belongs to the eyelid region, then this pixel will be assigned to the eyelid region no matter what the second and third segmentation maps PS², PS³ contain. If a pixel is not in the eyelid region 20a such as pixels 2, 3, then it will be assigned to the iris/cornea region 20b if it also falls within the iris/cornea region. Otherwise, it will be assigned to the sclera region 20c. Each pixel of each parametric segmentation map PS¹, PS², PS³ is therefore assigned to the corresponding distinctive eye region of the image geometric model 10 having the same coordinates through a direct and deterministic function of the set of geometrical parameters θ.

The segmentation neural network 12 generates three image segmentation maps NS¹, NS², NS³. Each image segmentation map NS¹, NS², NS³ assigns a probability, a log probability or score discrete value to each of its pixels to belong to a distinctive eye region of the input image observation 10. In other words, each image segmentation map may be seen as a probabilistic model that provides an estimation on how likely each of its pixels and the corresponding pixel of the input image observation 10 with the same coordinates belong to the same distinctive eye region. The first, second and third image segmentation maps NS¹, NS², NS³ are probabilistic models, as explained above, for example respectively for the cornea region, the sclera region and the eyelid region of the input image observation 10. Each pixel of each image segmentation map NS¹, NS², NS³ is assigned with a probability or a log probability discrete value to belong to the same distinctive eye region as the pixel of the input image observation having the same coordinates. The classification (probability assignment) of each pixel of the input image observation is performed by the learning machine, for example by a neural network, and may depend for example on its colour, brightness, spatial context, inter region relations and position.

As illustrated in FIG. 5, in the evaluation process of the direction of the gaze of the user, each pixel of the eyelid region 20a, the iris/cornea region 20b and the sclera region 20c of the corresponding parametric segmentation map PS¹, PS², PS³ is compared with the pixel of the corresponding image segmentation map NS¹, NS², NS³ having the same coordinates to determine how likely the input image observation 10 correspond to the image geometric model. More particularly, the probability or log probability discrete value of each pixel of each image segmentation map NS¹, NS², NS³ are selected only if the estimated distinctive eye region (i.e. the cornea/iris region, the sclera region and the eyelid region) of said each pixel corresponds to the distinctive eye region (i.e. the cornea/iris region, the sclera region and the eyelid region) assigned to the corresponding pixel with the same coordinates of the corresponding parametric segmentation map PS¹, PS², PS³.

The selected probability or log probability discrete values are added together to provide a value which is indicative of the probability that the input image observation correspond to the geometric model of the user's eye gazing at one particular direction. If the value is below the optimal value, one or more new image geometric models are generated, using the selected optimization step as discussed above, to find the adequate optical geometric configuration until the above value reaches the optimal value.

In another advantageous embodiment, instead of generating a hard-parametric segmentation map for each distinctive eye region for the image geometric model, a single soft parametric segmentation map of the image geometric model is calculated.

Three discrete values are assigned to each pixel of the soft parametric segmentation map. These discrete values represent each a probability or a log probability that each pixel of the soft parametric segmentation map corresponds to one of the three distinctive eye regions of the image geometric model, preferably the cornea/iris region, the sclera region and the eyelid region.

In parallel, the segmentation neural network 12 generates a single soft image segmentation map of the input image observation 10. At least three discrete values are assigned to each pixel of the soft image segmentation map. These discrete values represent each a probability or a log probability that each pixel of the soft image segmentation map corresponds to one of the at least three corresponding distinctive eye regions of the input image observation 10, preferably the cornea/iris region, the sclera region and the eyelid region.

The soft parametric and image segmentation maps are then merged together by multiplying each of said three discrete values assigned to each pixel of the parametric segmentation map with each of the corresponding three values assigned to each pixel of the soft image segmentation map with the same coordinates. The sum of the multiplied values for each pixel of said segmentation maps are indicative of how likely the model correspondence value corresponds to the image geometric model. Per pixel, this can be seen as a weighed sum of the probabilities given by the soft image segmentation map, where the weights are given by the soft parametric segmentation map.

Before the pixel-wise multiplication step, the soft image and/or parametric segmentation maps may be transformed through functions like the log, robust estimators. Moreover, the transformation may be such that a multiplication is no longer necessary and instead an addition or subtraction is performed.

The estimation of the eye-gaze direction and other eye-related geometric parameters of the user according to this embodiment may achieve better results accuracy as using soft parametric and image segmentation maps may better discriminate pixels located on adjacent edges of distinctive eye regions.

In an embodiment, the method comprises a step of computing how likely is a given geometric configuration (θ), independently of the image data, based solely on prior knowledge on the expected geometry. Prior knowledge on the expected geometry, also referred to as a prior term, which is discussed in WO 2015/192879, the content of which is hereby incorporated by reference, can further be additively or multiplicatively combined with the estimates given by the image segmentation maps and parametric segmentation maps.

The segmentation neural network 12 comprises multiple layers configured to generate an image segmentation map for an input. The neural network can be composed by one or a sequence of encoding-decoding or hourglass layers that achieve a transformation of the input such that the image segmentation is of the same resolution as the input, or at least a pixel correspondence can be established between the image segmentation map and the input.

The neural network may for example contain Convolutional layers used in standard Convolutional Neural Network (CNN) designed to recognize visual patterns directly from pixel images with minimal pre-processing. The network may advantageously be enhanced with a Residual Neural Network (ResNET) architecture which can let the network go deeper without gradient vanishing to enhance the performance of the image segmentation process.

The CNN may for example comprise three parts, an encoder, ResNET building blocks and a decoder. The encoder is configured to extract and compress context information into a feature map and comprises three convolutional layers. In each convolutional layer, reflection padding is performed to enlarge the image, so the size remains the same under convolution operator. Stride is used in the second and third convolutional layers to shrink the image.

The segmentation neural network 12 may comprise for example six ResNET building blocks. In each building block, there are two convolutional layers and each convolutional layer is followed by Batch Normalization and Rectified Linear Units (ReLU). The output of the final ReLU is added to the input feature map of the building block. The six RestNET building blocks are concatenated one by one. The size of the feature maps remains the same since no pooling and no stride are done inside the blocks.

The decoder, which follows the ResNET building blocks, is adapted to expand the feature map and infer the pixel categories. It contains two de-convolutional layers with stride. Both de-convolutional layers are followed by Batch Normalization and ReLU units. The decoder is configured to infer and recover objective information. The ResNET building blocks extend the encoder to refine the feature map.

The segmentation neural network may have been previously trained with UnityEYE which is a tool that can synthesize various age images with different skins, different eye shapes and different iris locations. Some of the data could be used for training, whereas others can be used for validation or testing. Other tools for synthetic data generation may be used.

The segmentation neural network training can also be enhanced by using training data from multiple modalities, such as RGB, infrared, SWIR, or any other variant, provided that annotations of pixel classes are available for the samples.

The segmentation neural network may also be trained first under a complex architecture, but its knowledge transferred to a more compact network through distillation strategies.

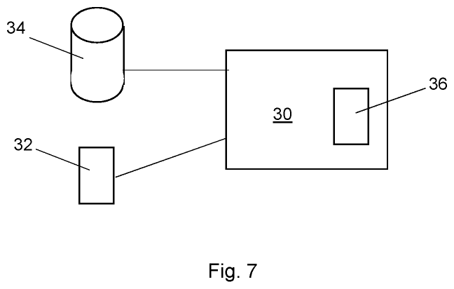

FIG. 7 schematically illustrates an apparatus for estimating an eye-gaze direction of the user. The apparatus may include a computing system 30, such as a personal computer, a server, a smartphone, a wearable computer or an optical head-mounted display such as Google Glass for example. An image capture element 32 such as a camera is connected or integrated to the computing system 30 for retrieving images of a user's face. A database 34 is used as part of the computing system 30 for storing user-specific parameters. The computing system 30 further includes a computer readable storage medium 36 storing a computer program comprising a set of algorithms of the segmentation neural network.

It has to be noted that depending on the embodiment, certain steps of the method according to the invention may be performed in different sequences or may be performed concurrently rather than sequentially.

Various modification and variations to the described embodiments of the invention will be apparent to those skilled in the art without departing from the scope of the invention as defined in the appended claims. For example, other methodologies to determine how likely the input image observation 10 corresponds to the image geometric model may be implemented.

1. A method for estimating eye-related geometric parameters of a user, comprising the steps of:
a. retrieving at least one input image observation corresponding to an image of the user's eye comprising distinctive eye regions;
b. using a learning machine for computing one or a plurality of image segmentation maps, so as to classify each pixel of said input image observation into at least one among a plurality of distinctive eye regions;
c. generating through a set of geometric parameters an image geometric model of the user's eye;
d. comparing the image geometric model with at least one image segmentation map;
e. based on this comparison, computing a model correspondence value indicating if said at least one input image observation corresponds to the geometric model of the user's eye;
f. repeating steps c. to e. if the value computed under step e. is below an optimal value wherein at least one parameter in the set of geometric parameters is changed under step c to generate a new image geometric model of a user's eye for each iteration of steps c. to e. until said model correspondence value reaches the optimal value, and
g. retrieving the eye-related geometric parameters from the latest image geometric model of the user's eye that has been generated.

2. Method of claim 1, wherein said at least one input image observation is augmented by providing data obtained from supervised, semi-supervised or unsupervised calibration procedures.

3. Method of claim 1, wherein said eye-related geometric parameters correspond to an eye gaze direction of the user, and wherein:
the image geometric model of the user's eye under step c. corresponds to user's eye gazing at one particular direction,
said at least one parameter in the set of geometric parameters is changed under step c. to generate a new image geometric model of a user's eye gazing at another direction for each iteration of steps c. to e. until said model correspondence value reaches said optimal value, and
the gaze direction is retrieved under step g. from said latest image geometric model.

4. Method of claim 1, wherein at least one parametric segmentation map is calculated from said image geometric model of the user's eye, wherein each pixel of said parametric segmentation map is classified into at least one among a plurality of distinctive eye regions.

5. Method of claim 4, wherein each pixel of said parametric segmentation map indicates at least one probability, log probability or score that this pixel belongs to at least one distinctive eye region.

6. Method of claim 5, wherein a plurality of parametric segmentation maps are calculated from said image geometric model, each said parametric segmentation map indicating to which distinctive eye region each pixel of a projection of said image geometric model belongs, or a probability, a log probability or a score associated with each pixel of a projection of said image geometric model that this pixel belongs to one distinctive eye region.

7. Method of claim 5, wherein said step d. comprises comparing the probability, log probability or score assigned to each pixel of at least one image segmentation map with the value of a pixel of at least one parametric segmentation map having the same coordinates.

8. Method of claim 5, comprising:
determining from at least one parametric segmentation map the distinctive region to which each pixel is supposed to belong according to the image geometric model;
as part of step d., determining from the at least one image segmentation map a pixel correspondence value corresponding to that distinctive region and indicating the probability, log probabilities or scores that this pixel belongs to that distinctive region; —as part of step e., adding said pixel correspondence values together to provide said model correspondence value

9. Method of claim 1, wherein at least one soft parametric segmentation map of the image geometric model is calculated from said image geometric model of the user's eye, at least two, preferably at least three values being assigned to each pixel of said soft parametric segmentation map, said values representing a probability, a log probability or a score that each pixel corresponds to each of said distinctive eye regions of said image geometric model.

10. Method of claim 9, wherein at least two, preferably at least three values are assigned to each pixel of said image segmentation map, said at least three values representing a probability, a log probability or a score that each pixel corresponds to each of said distinctive eye regions of said at least one input image observation.

11. Method of claim 10, wherein said soft parametric and image segmentation maps are merged together by multiplying each of said at least three values assigned to each pixel of the parametric segmentation map with each of the corresponding at least three values assigned to each pixel of the image segmentation map with the same coordinates, and adding the multiplied values for each pixel of said segmentation maps to provide said model correspondence value.

12. Method of claim 11, comprising a step of computing for each pixel a weighted sum of the probabilities or log probabilities or scores in each image segmentation map with the probability associated with the corresponding value of the corresponding pixel of the image segmentation map.

13. Method of claim 1, wherein said distinctive eye regions are preferably three distinctive eye regions selected from the group comprising the cornea, the pupil, the iris, the sclera and the eyelid

14. Method of claim 1, wherein said image segmentation maps are image probability maps indicating a probability or log probability associated with each pixel that this pixel belongs to one distinctive eye region.

15. Method of claim 1, wherein said image segmentation maps are image score maps indicating the score associated with each pixel that this pixel belongs to one distinctive eye region.

16. Method of claim 1, wherein the learning machine comprises a segmentation neural network configured to generate said image segmentation map based on the at least one input image observation.

17. Method of claim 16, wherein the segmentation neural network comprises multiple layers configured to generate an image segmentation map for an input

18. Method of claim 17, wherein the segmentation neural network comprises one or a sequence of encoding-decoding or hourglass layers configured to achieve a transformation of the input such that the image segmentation is of the same resolution as said input, or at least a pixel correspondence can be established between the image segmentation map and said input.

19. Method of claim 1, wherein said set of geometric parameters comprises a plurality of parameters among at least: eyeball rotation centre, visual axis offset, eyeball radius, cornea radius, limbus radius, pupil radius, eyelids opening or shape, and left and/or right eye corner.

20. Method of claim 1, said step a. comprising pre-processing an image from an image frame, said pre-processing comprising brightness adjustment, contrast adjustment, white balance adjustment, noise removal, scaling and/or cropping.

21. Method of claim 1, said step a. comprising pre-processing an image from an image frame, said pre-processing comprising pose head adjustment.

22. An apparatus for estimating eye-related geometric parameters, comprising:
a camera for capturing a user's face;
a database storing user-specific eye and facial geometric parameters, and
a computing system comprising a memory storing a computer program configured to perform the method of any preceding claim.

23. A computer readable storage medium storing a computer program, the computer program comprising a set of algorithms configured to perform the method of claim 1.
